(19) United States
(12) Patent Application Publication
(10) Pub. No.: US 2007/0176306 A1
(43) Pub. Date: Aug. 2, 2007

(54) Safety device for a humidifier

(76) Inventor: Ping Huang, Yung Kang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/344,255

(22) Filed: Feb. 1, 2006

(51) Int. Cl. B01F 3/04

(52) U.S. Cl. 261/72.1; 261/DIG. 65

(57) ABSTRACT

A safety device for a humidifier includes a housing, a water tank, a nozzle, a vapor producer and a water feeder. The water tank is positioned in the housing, and the nozzle is positioned above the water tank. The housing has a water intake connected with the water feeder. A sphere holder for holding a sphere is assembled between the water tank and the nozzle and the sphere can exactly clog the nozzle. When the water tank is collapsed, the sphere will disengage from the sphere holder to clog the nozzle. A hollow space is formed between the water feeder and the water tank and provided with a sluice gate, and a stop plate is provided for controlling water to pass through the sluice gate and for sealing up the sluice gate, able to prevent the water in the water tank from overflowing and flowing reversely.

### BACKGROUND OF THE INVENTION

1. Field of the Invention

This invention relates to a safety device for a humidifier, particularly to one provided with a sphere to be clogged in a nozzle for preventing the water in a water tank from overflowing to wet a floor or cause an accident of scald when the housing of a humidifier is collapsed. The safety device for the humidifier in the present invention is also provided with a stop plate positioned at the outer end of a connecting groove for controlling water to pass through the sluice gate of the connecting groove in one way and also for sealing up the sluice gate so as to prevent the water in the water tank from flowing reversely and the hot vapor therein from diffusing, thus insuring safety in use.

2. Description of the Prior Art

As commonly known, excessively dry air is harmful to a man's health, not only making a man's skin taut and mouth dry and even causing bleeding of a nose, but also producing more floating dust particles in the air to induce various diseases like asthma, emphysema and tracheitis. Researchers' Data show that when relative humidity reaches 55%, germs can hardly to spread and when relative humidity is over 65%, a man may feel uncomfortable in breathing and his immunity will drop, but when relative humidity is less than 20%, a man is likely to inhale a lot of dust particles and fall sick, or may feel fretful and dizzy because of static electricity produced in the dry air, and furniture, books or other articles may be quickened to become old and worn out. Taking Beijing in China for instance, its indoor relative humidity in winter is about 20%, which is much lower than the normal 40%-70% RH. In this case, a proper humidifier should be installed in a room to keep the indoor humidity under a normal condition for insuring health.

Common humidifiers are generally classified into three types according to their functions: the electric heating type, the supersonic wave type and the atomizing type. The electric heating-type humidifier also called as a vaporizing-type humidifier is provided with a heater for heating water to produce vapor to be released into the air. The supersonic wave-type humidifier is provided with a supersonic-wave oscillator for atomizing water into super-minute particles of 1-5 micron by means of supersonic-wave high frequency oscillation and then the vapor is evenly diffused into the air by a blower. The atomizing-type humidifier is provided with an atomizer for producing vapor mainly for medical treatment, facial making up or infant nursing.

The three types of humidifiers mentioned above are respectively composed of a housing, a water tank, a nozzle and a vapor producer. The water tank is positioned in the housing for storage of water and connected with the vapor producer for producing vapor. The vapor producer can be a heater, a supersonic-wave oscillator, an atomizer or other vapor-producing devices. The nozzle is positioned above the water tank for sending out vapor. The housing has its upper side bored with a water intake connected with a water feeder, which can be a closed container for filling water therein. When the water in the water feeder is used up, the feeder can be removed out for replacing with a new one or adding water therein. A present humidifier 9, as shown in FIG. 9, is provided with a water feeder 91, a connecting groove 92, a sluice gate 93 and a water reservoir 94. The water in the water feeder 91 will incessantly flow into the water tank 94 through the connecting groove 92 and the sluice gate 93 to keep the water in the water tank 94 at a certain level.

However, the foresaid conventional humidifiers have the following drawbacks in structure.

1. If the housing of the humidifier should be collapsed, the water in the water reservoir would overflow to wet the floor or the carpet in a room, thus causing trouble in cleaning.

2. When the water in the water tank of a humidifier is heated for producing vapor, its temperature will be raised up to 80° C.- 100° C. In this case, if the housing of the humidifier should be collapsed, the hot water in the water reservoir would overflow and possibly cause scald to persons around.

3. When the water in the water tank is very hot and if water is uncontrolled to flow into the water tank continuously, the water level of the water tank will rise to reach the connecting groove and the outlet of the water feeder, letting the connecting groove and the water feeder contact with the hot water. Thus, the housing of the humidifier, which is mostly made of plastic, may be deteriorated or even burned down.

4. When there is no water in the water feeder and the connecting groove, the vapor in the water tank will be diffused to reach the connecting groove and the water feeder and may cause damage to them.

### SUMMARY OF THE INVENTION

A first objective of the invention is to offer a safety device for a humidifier, provided with a sphere to be clogged in a nozzle for preventing the water in a water tank from overflowing when the housing of a humidifier is collapsed.

A second objective of the invention is to offer a safety device for the humidifier, provided with a stop plate assembled at the outer end of a connecting groove for sealing up the sluice gate of the connecting groove so as to prevent the water or the vapor in the water tank from flowing reversely.

For achieving the foresaid objectives, the humidifier of the present invention includes a housing, a water tank, a nozzle, a vapor producer and a water feeder. The water tank is positioned in the housing for storage of water and connected with the vapor producer for producing vapor. The nozzle is positioned above the housing for sending out vapor. The housing has its upper side bored with a water intake connected with the water feeder.

A sphere holder is installed between the water tank and the nozzle, and a sphere able to be exactly clogged in the nozzle is held on the sphere holder. If the water reservoir should be collapsed, the sphere will disengage from the sphere holder and roll to clog the nozzle closely so as to prevent the water in the water tank from overflowing.

A connecting groove is formed between the water feeder and the water tank and provided with a sluice gate for water to pass therethrough. A stop plate with a size matching with the sluice gate is pivotally assembled at the outer end of the connecting groove for controlling water to pass through the sluice gate only in one way and for sealing up the sluice gate, able to prevent the water in the water tank from flowing reversely.

### BRIEF DESCRIPTION OF DRAWINGS

This invention will be better understood by referring to the accompanying drawings, wherein:

FIG. 1 is an exploded perspective view of a safety device for a humidifier in the present invention;

FIG. 2 is a perspective view of the safety device for a humidifier in the present invention;

FIG. 3 is an upper view of the safety device for a humidifier in the present invention;

FIG. 4 is a partial magnified cross-sectional view of the safety device for a humidifier in the present invention;

FIG. 5 is a cross-sectional view of the housing of a humidifier in a collapsed condition in the present invention;

FIG. 6 is a cross-sectional view of the housing of the humidifier in a normally using condition in the present invention;

FIG. 7 is a cross-sectional view of the safety device for a humidifier in the present, showing that water flows into a water tank;

FIG. 8 is a cross-sectional view of the safety device for a humidifier in the present invention, showing that a sluice gate is sealed up by a stop plate; and

FIG. 9 is a cross-sectional view of a conventional humidifier.

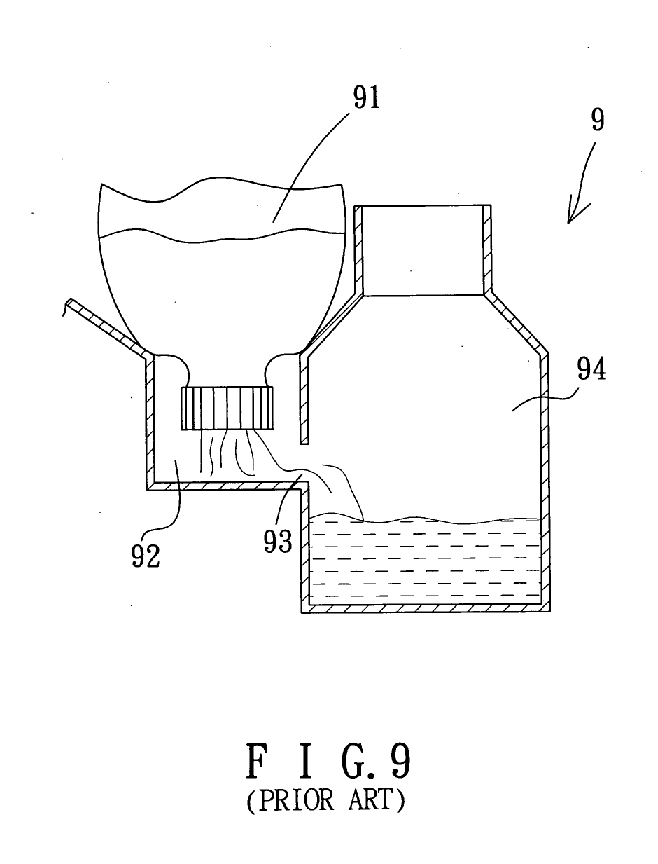

### DETAILED DESCRIPTION OF THE PREFERRED EMBODIMENT

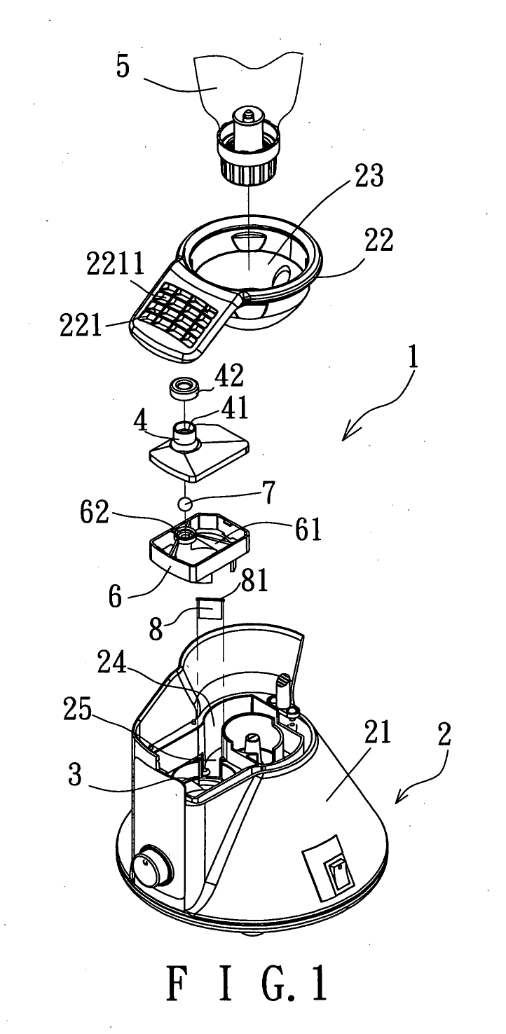

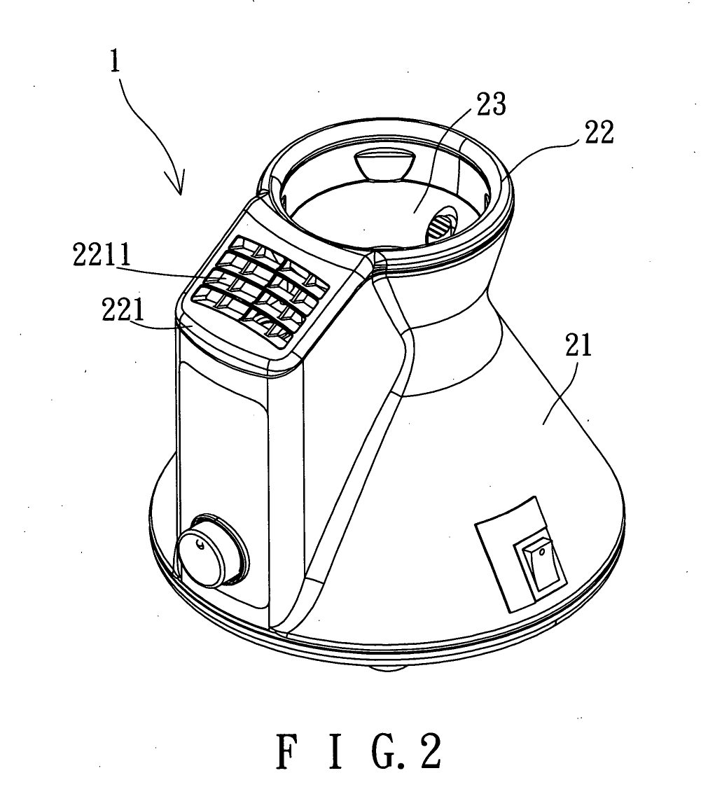

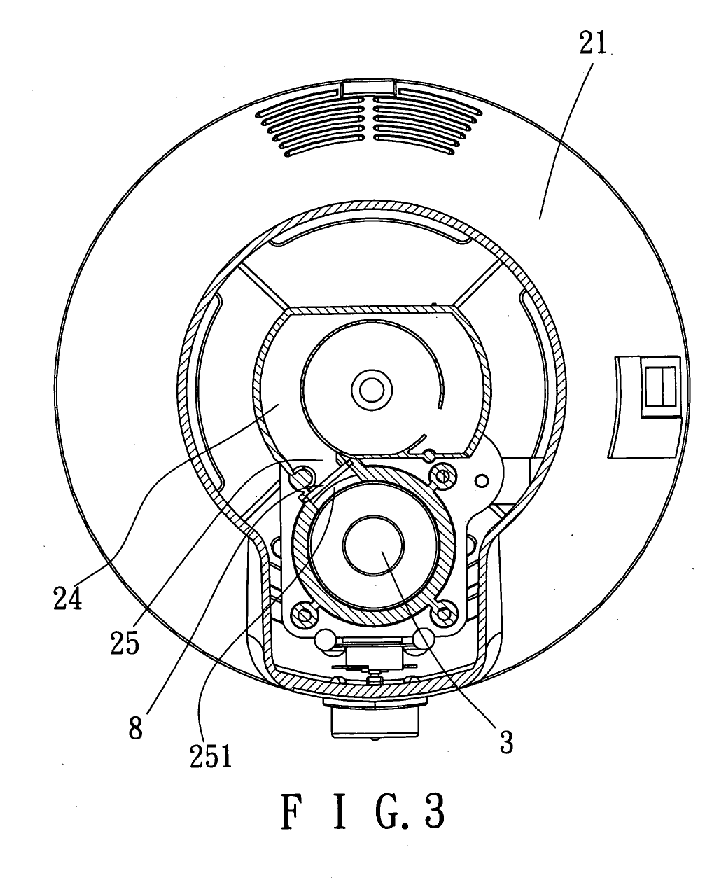

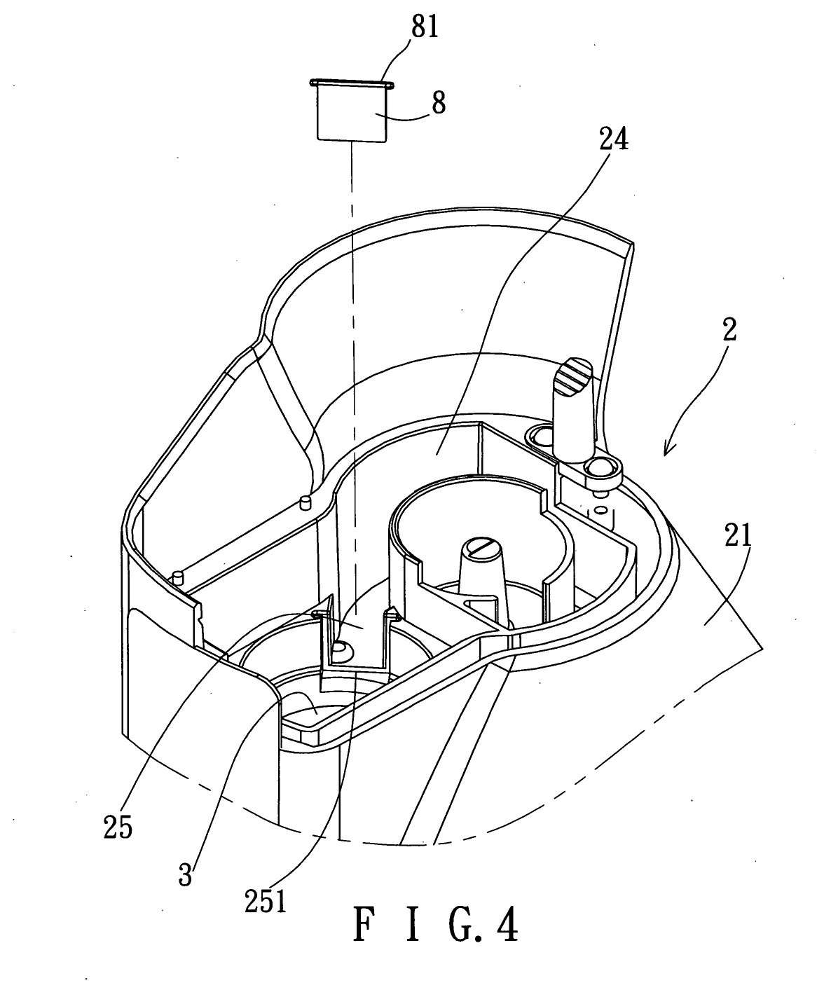

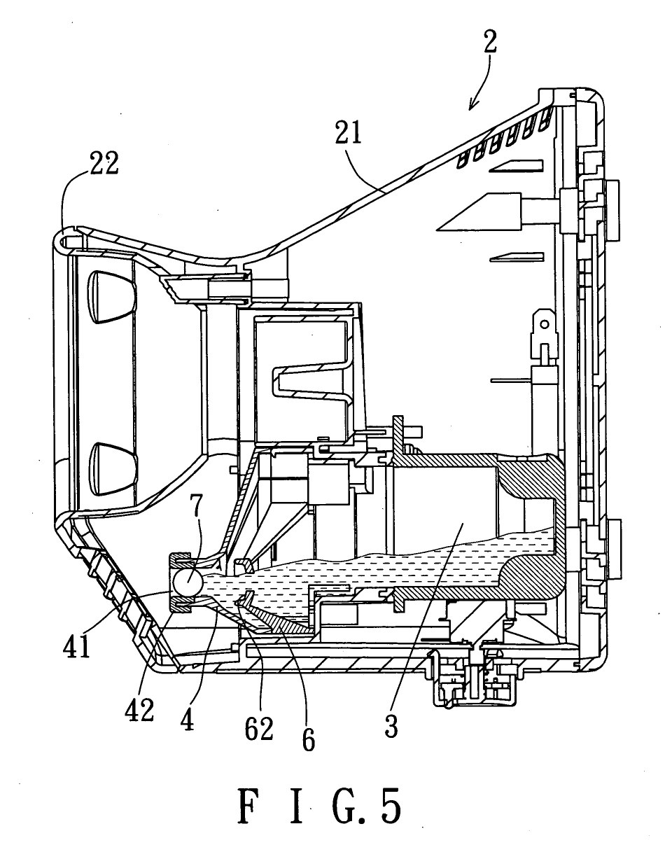

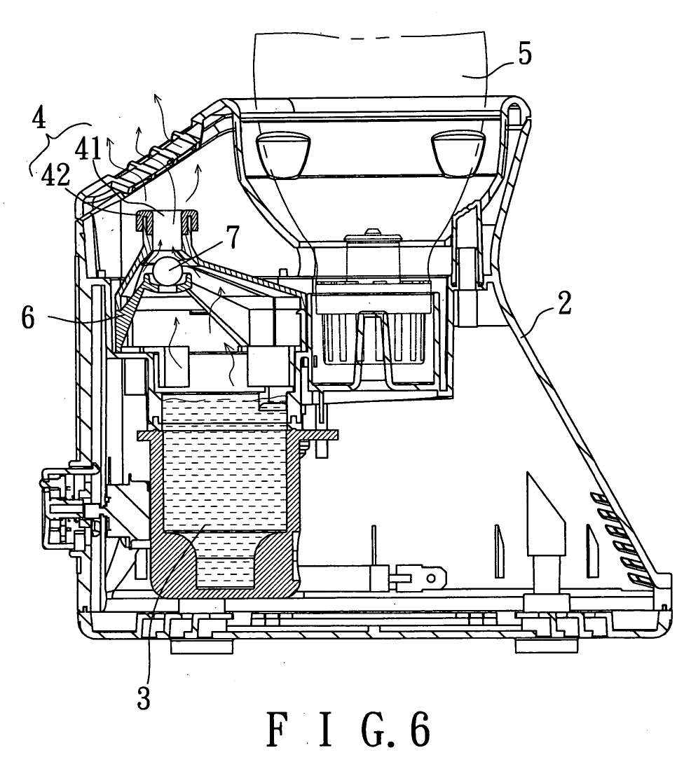

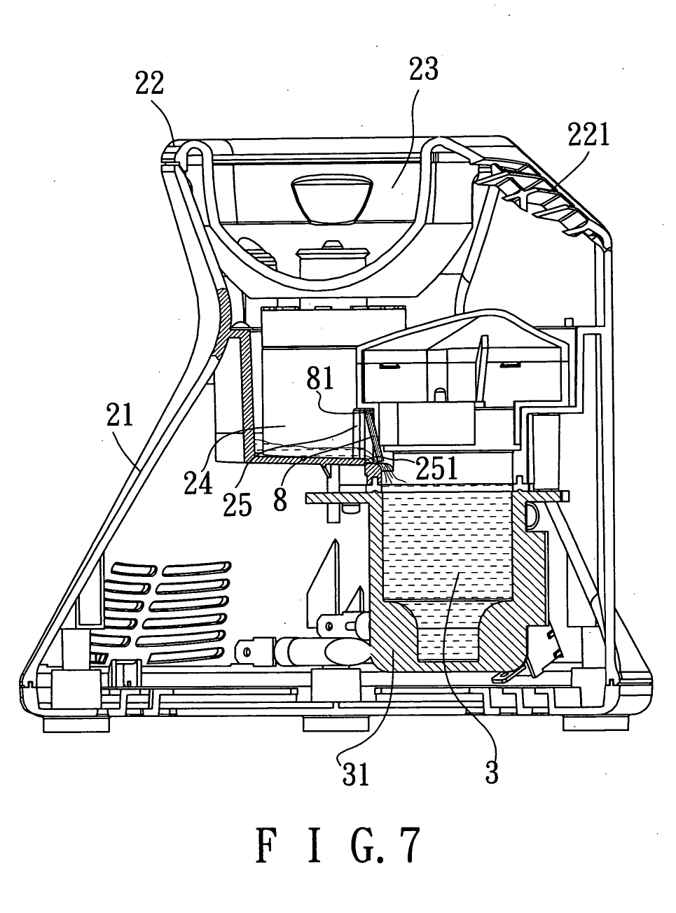

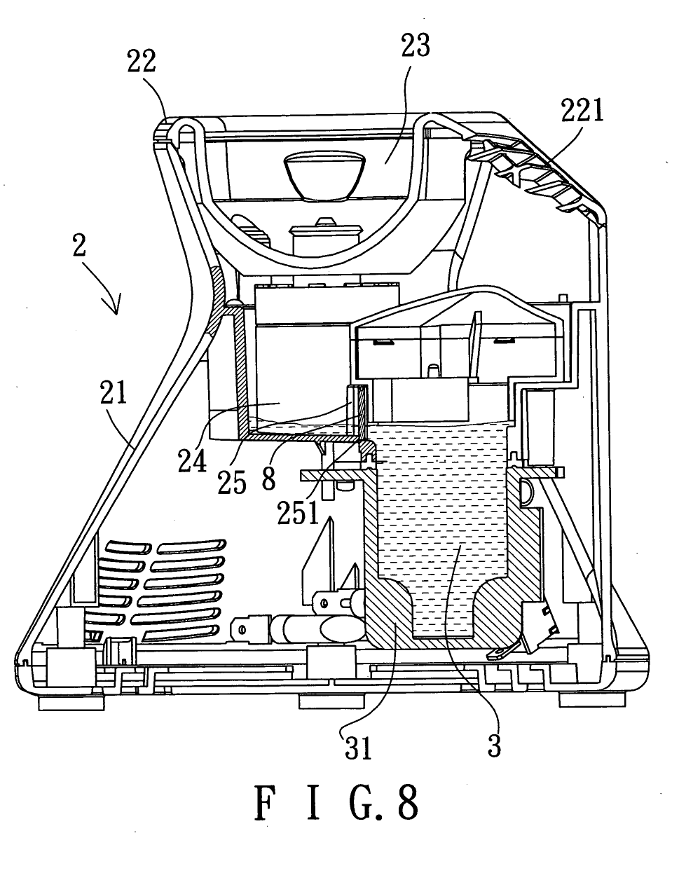

A preferred embodiment of a safety device for a humidifier 1 in the present invention, as shown in FIGS. 1-8, includes a housing 2, a water tank 3, a nozzle 4 with a passageway 41, a vapor producer 31 and a water feeder 5 combined together.

The housing 2 is composed of a base member 21 and an upper cover 22, and has its upper side bored with a water intake 23, and the water feeder 5 is connected with the water intake 23 of the housing 2 for continuously supplying the water reservoir with water.

The water tank 3 is positioned in the housing 2 and connected with the vapor producer 31 for producing vapor.

The vapor producer 31 can be a heater, a supersonic-wave producer, an atomizer or other proper vapor-producing devices.

The nozzle 4 is positioned above the water tank 3 for sending out vapor. A cover member 221 regularly bored with a plurality of air vents 2211 is disposed on the housing 2 at a corresponding position of the nozzle 4 for segregating persons from the nozzle 4 and for the vapor spurted out of the nozzle 4 to pass therethrough. Further, the nozzle 4 can be connected with a flexible pipe (not shown) for conveying vapor to a farther place for use of facial making up or sterilizing.

A sphere holder 6 installed between the water tank 3 and the nozzle 4 is composed of a conical member 61 and a holding tray 62 bored with a through hole 621 in the center. The sphere holder 6 is for holding thereon a sphere 7 with a certain weight, such as a steel ball or on iron ball, and the through hole 621 functions to steadily hold the sphere 7. A gap is formed between the sphere 7 and the passageway 41 of the nozzle 4 for facilitating vapor to pass therethrough, and the volume of the sphere 7 can exactly be clogged in the passageway 41 of the nozzle 4. Further, the nozzle 4 has its circumferential edge fitted with a soft pad 42 made of silica gel, which will be properly deformed elastically for clamping the sphere 7 when the sphere 7 rests against the soft pad 42, thus enabling the sphere 7 to be closely clogged in the nozzle 4.

By so designing, when the housing 2 together with the water tank 3 is collapsed, the sphere 7 will disengage from the holding tray 62 of the sphere holder 6 to be clamped by the soft pad 42 and clogged in the passageway 41 of the nozzle 4, and simultaneously the water pressure will push one side of the sphere 7 to help the sphere 7 to be closely clogged in the nozzle 4, thus preventing the water in the water tank 3 from overflowing. When the housing 2 is placed upright again, the sphere 7, by its own weight, will disengage from the soft pad 42 of the nozzle 4 and fall back to the sphere holder 6 to enable vapor to be sent out through the nozzle 4 as usual.

In addition, a hollow space 24 is formed between the water feeder 5 and the water tank 3 and provided with a sluice gate 25 for water to pass therethrough. A stop plate 8 having a size matching with the sluice gate 25 is assembled at the outer end of the hollow space 24 to be actuated to seal up the sluice gate 25. The stop plate 8 has its upper end fixed with a pivotal rod 81 pivotally assembled with the opposite sides of the sluice gate 25 and its lower end suspended in midair to be actuated to rest against a stepped portion 251 at the lower side of the sluice gate 25. Thus, water can pass through the sluice gate 25 only in one way and the water in the water tank 3 can be prevented from flowing reversely. The stepped portion 251 at the lower side of the sluice gate 25 enables the stop plate 8 to closely seal up the sluice gate 25.

The stop plate 8 light and not easy to be damaged is restricted to be turned open for an angle of 1-2 mm for water to pass through the sluice gate 25 and flow into the water tank 3, avoiding the stop plate 8 being turned fully open and unable to carry out water blocking. When the water level of the water tank 3 rises to reach the stop plate 8, water pressure will push the stop plate 8 to move inward and rest against the stepped portion 251 at the lower side of the sluice gate 25 and closely clog the sluice gate 25, thus not only stopping the water of the water feeder 5 from flowing into the water tank 3 any longer, but also preventing the water in the water tank 3 from flowing reversely and getting into the hollow space 24. By so designing, water can be supplied incessantly and the hot water or the hot air in the water tank 3 can be prevented from diffusing.

As can be understood from the above description, this invention has some advantages described as follows.

1. The sphere functions to closely clog the nozzle for preventing the water in the water tank from overflowing to wet the floor and the carpet in a room or cause scald to persons around in case the housing of a humidifier should be collapsed, thus insuring safety in use.

2. The stop plate can be controlled to permit the water feeder to supply water incessantly and also can be actuated to seal up the sluice gate for preventing the hot water or hot air in the water tank from flowing reversely, able to avoid the housing of the humidifier being deteriorated or burned down.

3. The safety device of this invention is simple in structure and low in cost, but has excellent effect, having great utilization value of products.

While the preferred embodiment of the invention has been described above, it will be recognized and understood that various modifications may be made therein and the appended claims are intended to cover all such modifications that may fall within the spirit and scope of the invention.

What is claimed is:

1. A safety device for a humidifier comprising a housing, a water tank, a nozzle, a vapor producer and a water feeder, said water tank positioned in the interior of said housing for storage of water, said water tank connected with said vapor producer for producing vapor, said nozzle assembled above said water tank for sending out vapor, said housing having its upper side bored with a water intake connected with said water feeder; and,
characterized by a sphere holder provided between said water tank and said nozzle and a hollow space formed between said water feeder and said water tank, said sphere holder holding a sphere thereon, the volume of said sphere exactly able to be closely clogged in said nozzle, said sphere disengaging from said sphere holder and rolling to clog said nozzle for preventing the water in said water tank from overflowing when said water tank is collapsed, said hollow space provided with a sluice gate for water to pass therethrough, a stop plate having a size matching with said sluice gate assembled at the outer end of said hollow space for sealing up said sluice gate, said stop plate controlled to permit water to pass through said sluice gate only in one way, said stop plate actuated to seal up said sluice gate for preventing the water in said water tank from flowing reversely.

2. The safety device for a humidifier as claimed in claim 1, wherein said nozzle has its circumferential edge fitted with a soft pad for clamping said sphere to enable said sphere to closely clog said nozzle when said sphere rests against said soft pad.

3. The safety device for a humidifier as claimed in claim 1, wherein a cover member with plural air vents is assembled at an upper portion of said housing for separating said nozzle from persons and for vapor to pass therethrough.

4. The safety device for a humidifier as claimed in claim 1, wherein said nozzle is connected with a flexible pipe for conveying vapor.

5. The safety device for a humidifier as claimed in claim 1, wherein said sphere holder is composed of a conical supporter and a holding tray having a through hole in the center.

6. The safety device for a humidifier as claimed in claim 1, wherein said stop plate has its upper end pivotally assembled with the upper opposite sides of said sluice gate and its lower end suspended in midair to be actuated to rest against a stepped portion at the outer side of said sluice gate for closely sealing up said sluice gate.

7. The safety device for a humidifier as claimed in claim 1, wherein said stop plate is restricted to be turned open for a certain angle.
